(19) United States
(12) Patent Application Publication
(10) Pub. No.: US 2010/0057953 A1
(43) Pub. Date: Mar. 4, 2010

(54) DATA PROCESSING SYSTEM

(75) Inventors: Bup Joong KIM, Daejeon (KR); Sun Me KIM, Daejeon (KR); Hong Ju KIM, Daejeon (KR); Byung Jun AHN, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/434,240

(22) Filed: May 1, 2009

(30) Foreign Application Priority Data
Aug. 27, 2008 (KR) 10-2008-0084050

(51) Int. Cl. G06F 3/00

(52) U.S. Cl. 710/52

(57) ABSTRACT

There is provided a data processing system comprising at least one processing module having at least one processor processing data and a data input/output unit that classifies and buffers input data received from an external medium, applies the input data to a processing module capable of processing the input data among the at least one processing module such that the input data is processed, classifies and buffers output data processed by the at least one processing module and outputs the output data to an external device. Accordingly, a processing module can be easily added or changed, and thus integration and variableness of processing resources can be improved to code with an increase in the quantity of input/output data, costs required to support a new service and upgrade the data processing system can be minimized, difficulty in maintaining processing can be alleviated and capability of coping with trouble in the data processing system.

### CROSS-REFERENCE TO RELATED APPLICATION

This application claims the benefit of Korean Application No. 10-2008-0084050, filed on Aug. 27, 2008 in the Korean Intellectual Property Office, the disclosure of which is incorporated herein by reference.

### BACKGROUND OF THE INVENTION

1. Field of the Invention

The present invention relates to a data processing system, and more particularly, to a data processing system which easily adds and changes processing resources and facilitates data distribution when processing resources are changed.

The present invention is derived from a study conducted as a part of the development of the packet-optic integrated switch technology by the Ministry of Information and Communication and the Institute for Information Technology Advancement [Project Management No. 2008-S-009-01, Project Title: Development of packet-optic integrated switch technology].

2. Discussion of the Related Art

Generally, processing resources are required to control, manage and process flow of data in apparatuses or equipment including an embedded device such as a personal computer (PC), a communication environment, a mobile terminal or the like. Here, the processing resources include the computing capability of a processor required to process data, capacities of memories, channels, input/output bandwidths, I/O channels corresponding to data paths and bandwidths, and performance of a software element such as an operating system (OS), a driver, application software or the like.

The quantity of data that is required to be transmitted, received and processed by recent communication equipment, PC, mobile terminals and various embedded environment devices increases at an exponential rate and consumption of processing resources required to process data also increases in proportion to the quantity of data. Accordingly, the performance and integration of a hardware device required to process data are improved and a variety of devices and methods are used to process data.

Although hardware devices adapted to rapidly process data and support various and complicate application services are in the market, devices developed in relation to a specific service die if the specific service does not occupy a position in the market, and thus efforts and costs for development of the devices are gone to nothing in many cases.

Hardware equipment and devices include hardware that is optimized to a specific operation and can perform only the specific operation, universal processors that can support any operation and is not optimized to a specific operation, and specialized processors that guarantee a specific level of variableness in a specific service or application category. However, these hardware equipment and devices have difficulty in being adapted to a variation in the market and the advent of new service due to limitations of the hardware equipment and devices or lack of methods of utilizing the hardware equipment and devices. Particularly, in the case of hardware specialized for a specific application service, the hardware can become useless if the service is declined, and thus hardware manufactures hesitate to develop hardware for supporting a specific service. Even in the case of hardware that provides a specific level of variableness, the hardware is not smoothly supplied when expected profits decrease due to occupation of dominant service/equipment providers in the market, and thus the range of selection of hardware that can be used by a new provider to support a service is narrowed and the hardware loses its position in the market.

Meanwhile, an inexpensive high performance universal processor that has been recently on the market can process at least one operation in parallel because cores of various kinds are included therein. Furthermore, universal processors having frequently used IO or processing resources that are required in a specific environment such as a mobile environment, a PC environment, a communication environment, a vehicle environment and the like are provided. These universal processors can support functions and services superior to those of dedicated hardware. Particularly, the use of processors having a structure that can be easily varied in a variable environment in which a new function is added or upgraded becomes important. However, when it is required to execute a function that cannot be supported by the performance and resources of a universal processor or to add or change processing resources in the existing apparatus or equipment, acceptance and transplantation of the processing resources instead of the performance or use of a processor are problematical.

Vehicles, communication equipment, ships and airplanes include blocks respectively specialized for sets of functions and each of the blocks includes modules that respectively support detailed functions in most cases. These modules are required to obtain the best result with minimum resources, to be easily maintained, to have high capability of coping with trouble in their operations and to be easily upgraded. Particularly, it is required to change processing resources in order to easily add and change an application service and a function. To achieve this, the modules must have a structure that allows the processing resources to be easily changed and varied.

In the case of a router of communication equipment, for example, an increase in the data input/output speed of the router increases the quantity of processed data and causes the consumption of increased quantity of processing resources. Furthermore, it is required to support processing resources superior to the existing processing resources needed for simple data forwarding and to provide processing resources specialized to a new data processing service in order to support the new data processing service. That is, it is required to add new resources to the existing processing resources in order to accept new services while maintaining the existing services. To achieve this, an apparatus and a method capable of easily accepting a plurality of processing resources, easily allocating and changing operations are required.

### SUMMARY OF THE INVENTION

It is an object of the present invention to provide a data processing system which easily adds and changes processing resources for supporting a new service, easily allocates and changes operations with the added or changed processing resources.

The object of the present invention can be accomplished by a data processing system including at least one processing module having at least one processor processing data and a data input/output unit that classifies and buffers input data received from an external medium, applies the input data to a processing module capable of processing the input data among the at least one processing module such that the input data is processed, classifies and buffers output data processed by the at least one processing module and outputs the output data to an external device

The data processing system of the present invention can improve integration and variableness of processing resources to cope with the quantity of increased input/output data, minimize costs required to support a new service and upgrade equipment, alleviate difficulty in performing processing maintenance and enhance capability of coping with trouble in the data processing system because the data processing system can easily add or change a processing module. Furthermore, processing modules are constructed in such a manner that the processing modules share information on their functions or a memory state and a host bridge device and the processing modules classify input data and output data according to data type (flow), and thus it is easy to allocate the processing module or processors for processing data.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a data processing system according to an embodiment of the present invention;

FIG. 2 is a block diagram of a data processing system according to another embodiment of the present invention;

FIG. 3 is a block diagram illustrating allocation of functions of processing modules illustrated in FIG. 1 and message paths;

FIG. 4 is a block diagram of a data input/output unit and a processor of the data processing system illustrated in FIG. 1 according to an embodiment of the present invention;

FIG. 5 is a conceptional view illustrating an operation of buffering and processing input data in the data processing system illustrated in FIG. 4;

FIG. 6 is a block diagram of a data input/output unit and a processor of the data processing system illustrated in FIG. 1 according to another embodiment of the present invention;

FIG. 7 is a conceptional view illustrating an operation of buffering and processing output data in a data processing system according to another embodiment of the present invention;

FIG. 8 illustrates transmission of output data between a processing module and a host bridge device in the data processing system illustrated in FIG. 7; and

FIG. 9 is a block diagram of a data processing system according to another embodiment of the present invention.

### DETAILED DESCRIPTION OF THE PREFERRED EMBODIMENTS

Hereinafter, the present invention will be described below with reference to the accompanying drawings.

In a data processing system according to the present invention, a processing module is easily added and changed and a data input/output unit can distribute data when a processing module is added or changed because the data input/output unit and the processing module share information.

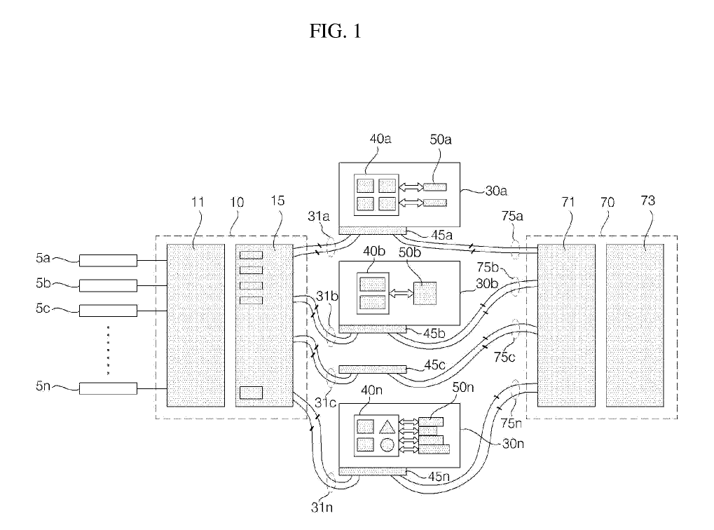

FIG. 1 is a block diagram of a data processing system according to an embodiment of the present invention.

Referring to FIG. 1, the data processing system includes a data input/output unit 10 that transmits, receives and buffers data, a plurality of processing modules 30a through 30n that process and arrange data received from the data input/output unit 10 and perform operations on the received data, and a switching connector 70 for extending the data processing system.

The data input/output unit 10 includes a physical layer 11 that physically processes data input/output to/from the data input/output unit 10 and a host bridge device 15 that is connected to the processing modules 30a through 30n and buffers data. The physical layer 11 and the host bridge device 15 can be integrated into a single physical device or can be respective physical devices.

The physical layer 11 is connected to at least one data line connector 5a through 5n connected to a wired/wireless medium and data is input/output to/from the data input/output unit 10 through the data line connector 5a through 5n.

The host bridge device 15 transmits/receives data to/from the processing modules 30a through 30n through serial or parallel interfaces. The interfaces can use the same interfacing method or different interfacing methods. For example, the host bridge device 15 and the processing modules 30a through 30n can use serial PCI-Express or sRIO (serial Rapid IO), parallel PCI, SPI or XAUI, or other user-defined and standardized interfaces. The processing modules 30a through 30n respectively include processors 40a through 40n, memories 50a through 50n, and connectors 45a through 45n.

The processing modules 30a through 30n support processing resources for processing data and can have different contents and forms. In the case of data that requires authentication, for example, the processing modules 30a through 30n can include processors 40a through 40n having an authentication function instead of universal processors to process the data requiring authentication. In the case of data that requires to be processed at a high speed, the processing modules 30a through 30n can include processors 40a through 40n having a digital signal processing (DSP) function to process the data. In the case of data that can be processed by a general processing function, the processing modules 30a through 30n can include universal processors 40a through 40n to process the data.

The processors 40a through 40n respectively include a single core or multi-core that arranges and processes input/output data and performs operations on the input/output data. Each of the processors 40a through 40n can include at least one of multiple cores of different types, multiple cores of a single type and a single core. Each of the processing modules 30a through 30n can include at least one processor of a single type or various types.

When the data processing system includes the processors 40a through 40n of various kinds or the processing modules 30a through 30n of various kinds, as described above, different hardware configurations of the processors 40a through 40n and the memories 50a through 50n can be overcome using an OS, a driver or application software to maintain consistency and diversification in data processing in order to consistently maintain the existing data processing function. Accordingly, various hardware devices and processing resources can be accepted and the range of function of supporting the various hardware devices and processing resources can be varied in a wide range. Furthermore, the processing modules 30a through 30n can be changed while the data processing system is operated, and thus it is easy to cope with trouble in the data processing system. This facilitates extension and upgrade of processing resources.

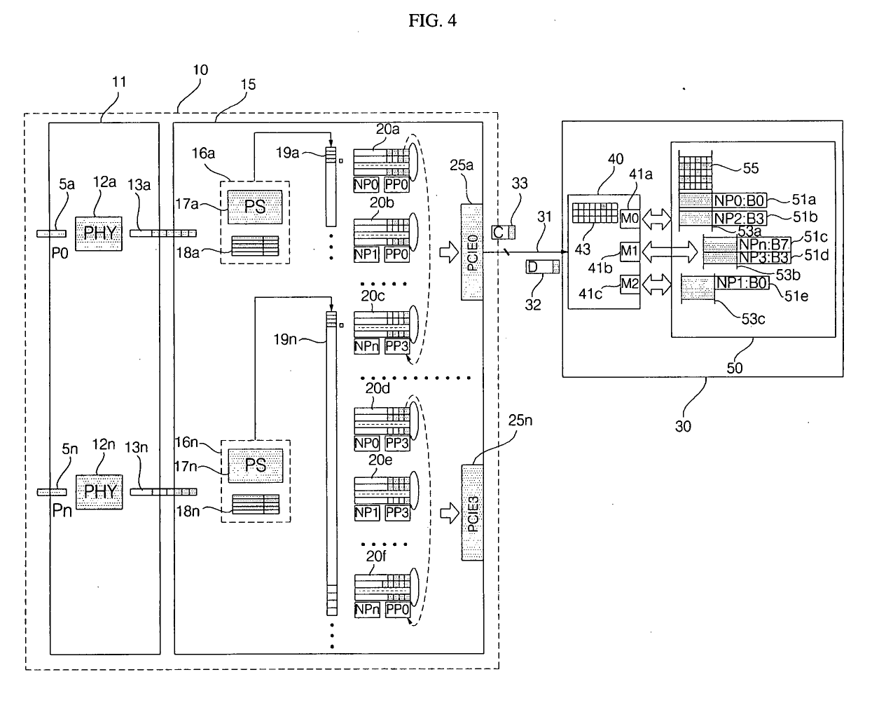

The memories 50a through 50n store data and the data processing system includes at least one memory. Some processor can include multiple memory channels 41a, 41b and 41c (illustrated in FIG. 4). A processing module including a processor having the multiple memory channels 41a, 41b and 41c can store input data in a position separately from the memory channels 41a, 41b and 41c according to the type of the input data. In the case where the data processing system includes the multiple memory channels 41a, 41b and 41c, a predetermined upper processor among the processors 40a through 40n or a predetermined upper processing module among the processing modules 30a through 30n can control allocation and/or distribution of input data for the respective processing modules 30a through 30n on the basis of the whole processing resources and a data processing policy when a processing module is changed/modified/added while the data processing system is operated. Even when some processing module has trouble, data assigned to the processing module having trouble can be allocated to a processing module in the normal state.

The processing modules 30a through 30n support a plug-and-play function in order to facilitate addition and change of a processing module while the data processing system is operated when the performance of the data processing system is required to be improved or the data processing system has trouble.

To achieve this, the connectors 45a through 45n for respectively connecting the processing modules 30a through 30n to the data input/output unit 10 are provided. The number of connectors 45a through 45n can correspond to the maximum number of processing modules 30a through 30n that can be included in the data processing system. Since the connectors 45a through 45n are connected to the data input/output unit 10 at all times, setting of a new processing module is completed only by connecting the new processing module to a corresponding connector when the new processing module is added for upgrade or replaces a processing module having trouble.

The processing modules 30a through 30n can be physically separated from the data input/output unit 10 or integrated with the data input/output unit 10. Otherwise, these two forms can be mixed.

The switching connector 70 includes a switch connecting host bridge device 71 and a switch interface 73. The switch connecting host bridge device 71 is connected to the connectors 45a through 45n of the processing modules 30a through 30n through serial or parallel interfaces 75a through 75n, respectively, and receives/transmits data. The switch interface 73 is connected to other neighboring processing modules to extend the data processing system. Accordingly, it is possible to connect other processing modules and a data input/output unit to the data processing system by using the switching connector 70 to extend the data processing system when there are a large number of data line connectors 5a through 5n and a large quantity of data to be processed.

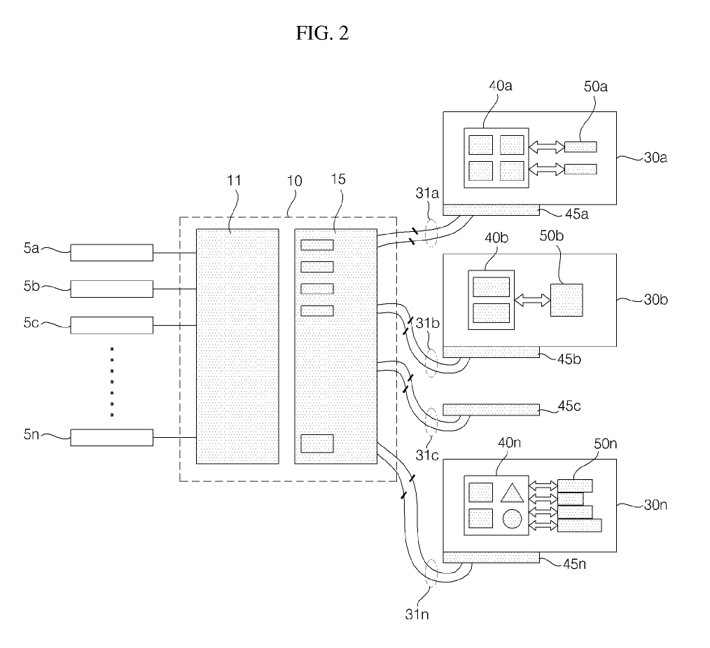

FIG. 2 is a block diagram of a data processing system according to another embodiment of the present invention. The data processing system illustrated in FIG. 2 does not include the switching connector illustrated in FIG. 1.

Referring to FIG. 2, the data processing system includes the data input/output unit 10 and the plurality of processing modules 30a through 30n. This data processing system can be constructed when there are a small number of data line connectors 5a through 5n connected to the data input/output unit 10 and a small quantity of data to be processed. The data input/output unit 10 and the processing modules 30a through 30n illustrated in FIG. 2 have the same configurations and functions as those of the data input/output unit 10 and the processing modules 30a through 30n illustrated in FIG. 1 so that detailed explanations thereof are omitted.

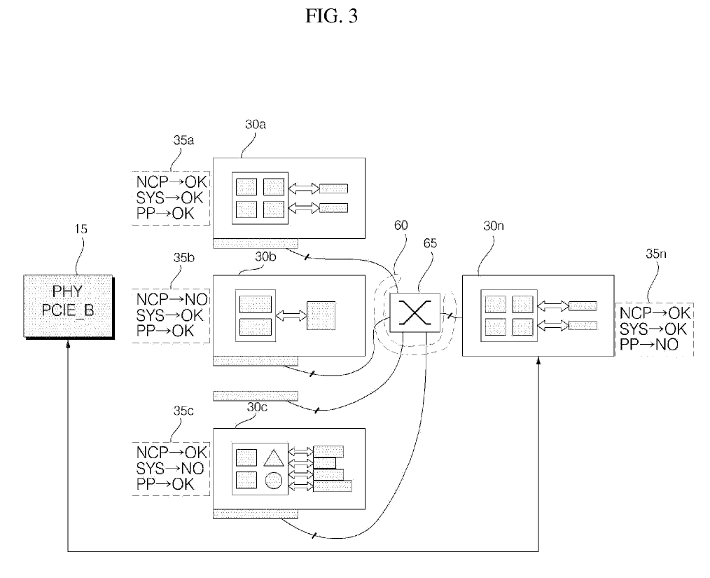

FIG. 3 is a block diagram illustrating distribution of functions among the processing modules 30a through 30n illustrated in FIG. 1 and message paths.

The processing modules 30a through 30n illustrated in FIG. 1 can have the configuration illustrated in FIG. 3 and exchange information according to the configuration. Referring to FIG. 3, the processing modules 30a, 30b and 30c respectively have function information 35a, 35b and 35c corresponding to information on functions that can be performed by the processing modules 30a, 30b and 30c. Control message paths 60 and 65 are constructed such that the processing modules 30a, 30b and 30c can share the information on the functions thereof through message exchange.

The control message paths 60 and 65 correspond to passages through which a control message and a status message are exchanged among the processing modules 30a, 30b and 30c. The control message paths 60 and 65 can be constructed separately from data paths through which input/output data is transmitted or can be constructed through the data paths by using a relay function of the host bridge device 15. Otherwise, both the separate paths and the data paths can be used as the control message paths 60 and 65. In other words, the control message paths 60 and 65 can be constructed using an additional internal connector, using data paths for transmitting/receiving data to/from the data input/output unit 10 and/or the switching connector 70, or using both the additional internal connector and the data paths. Here, an Ethernet channel and an Ethernet switch can be used as the internal connector and the internal connector can use serial PCI-Express or sRIO, parallel PCI, SPI, XAUI or other user-defined and standardized interfaces.

In the case where the control message paths 60 and 65 are constructed using the data paths, when a control message is transmitted between processing modules among the processing modules 30a, 30b and 30c through the data paths, the host bridge device 15 recognizes that the control message is internal data transmitted between the processing modules and transmits the control message to the corresponding processing modules. Furthermore, an internal message can be transmitted/received between processing modules by using a relay function of the switching connector 70.

The processing modules 30a through 30n illustrated in FIG. 1 have a system control function SYS, a packet processing function PP, and a connection control function NCP that processes a control message transmitted/received to/from an external network or a connecting node.

The system control function sets and controls the data input/output unit 10 through an additional interface or data path. The processing modules 30a and 30b having the system control function perform control and management functions system by system, board by board and module by module.

The processing modules 30a, 30b and 30c having the packet processing function perform functions related to processing and input/output of data.

The processing modules 30a and 30c having the connection control function process messages such as a control message, a status message, a routing message, and a protocol message and transmit/receive the messages to/from an external network or a connecting part to which the data line connectors 5a through 5n are connected.

Each of the processing modules 30a through 30n can execute one of the aforementioned functions or multiple functions if required. That is, the processing modules having the system control function, the processing modules having the packet processing function and the processing modules having the connection control function can have respective independent forms or can be integrated such that at least two functions can be executed. When at least one of the processing modules 30a through 30n is used, the quantity of data processed by each processing module must be allocated in consideration of the function of each processing module and consumption of processing resources according to execution of the function of each processing module. When the processing modules 30a through 30n include the plurality of processors 40a through 40n, the processors 40a through 40n can respectively perform different functions, execute the same function, or respectively carry out the same function on different levels.

The processing modules 30a through 30n share information on functions that can be performed by the processing modules 30a through 30n and the processing module 30n that will execute its function is selected through transmission and reception of an internal message among the processing modules 30a through 30n by using the shared information. When the processing module 30n executes the function, the processing modules 30a through 30n share information on consumption of processing resources according to execution of the function and processing resources left over.

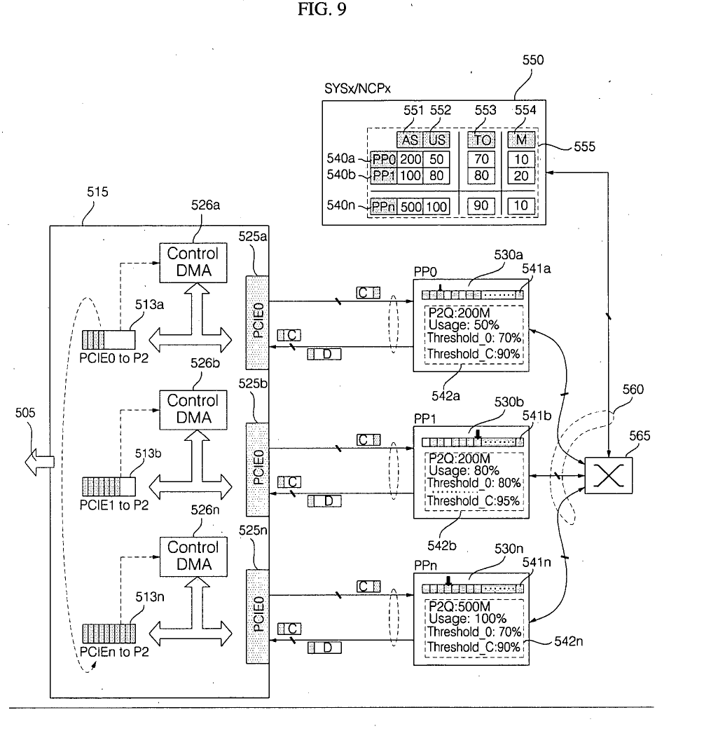

An upper processor concept can be used for information sharing among the processing modules 30a through 30n and distribution of the functions of the processing modules 30a through 30n. The upper processor can be provided as an upper processing module distinguished from the general processing modules 30a through 30n. Otherwise, one of the general processing modules 30a through 30n can be selected as the upper processor to perform the function of the upper processing module. The upper processing module sets and controls the data input/output unit 10. Here, the upper processing module can indirectly set and control the data input/output unit 10 by using the processing modules 30a through 30n that execute the packet processing function. Otherwise, the upper processing module can set and control the data input/output unit 10 by using a control path thereof or a host interface line that connects the data input/output unit 10 to the processing modules 30a through 30n. The upper processing module will be described in more detail later with reference to FIG. 9.

FIG. 4 is a block diagram of the data input/output unit 10 and a processor 40 of the data processing system illustrated in FIG. 1 according to an embodiment of the present invention. The configurations and operations of the data input/output unit 10 and the processor 40 based on input of data will now be explained with reference to FIG. 4.

FIG. 4 illustrates the data input/output unit 10, the processor 40 among at least one processor included in a processing module 30, and a memory 50 included in the processing module 30. An operation of processing input data in the physical layer 11 and the host bridge device 15 of the data input/output unit 10 and transmitting the processed data to the memory 50 connected to the processor 40 of the processing module 30 will now be explained with reference to FIG. 4.

The physical layer 11 is connected to the data line connectors 5a through 5n and includes physical layer processors 12a through 12n and buffers 13a through 13n. The physical layer processors 12a through 12n process data input through the data line connectors 5a through 5n such that a data line medium dependent work is finished and the buffers 13a through 13n store the data and provide the data to the host bridge device 15.

The host bridge device 15 includes data sorters 16a through 16n that sort input data according to data type, input/output buffer selectors 19a through 19m that guide data to selected input/output buffers 20a through 20n, a plurality of input/output buffers 20a through 20n that store data according to data type, and host interface ports 25a through 25n that execute a connecting and interfacing function of an interface.

The data sorters 16a through 16n respectively include sorting tables 18a through 18n and data sorting units 17a through 17n. The sorting tables 18a through 18n store information required to classify data, for example, the header of input data, some of contents of the input data and combination of some of the contents, and values of the input/output buffers 20a through 20n matched to the information.

The data sorting units 17a through 17n classify data with reference to the information stored in the sorting tables 18a through 18n, transmit the classified data to the input/output buffer selectors 19a through 19n and control the classified data to be delivered to a corresponding input/output buffer among the input/output buffers 20a through 20n. The data sorting units 17a through 17n select the processor 40 corresponding to a destination of the input data and the input/output buffers 20a through 20n, receive buffer status information from the input/output buffers 20a through 20n and perform buffer management and data input control. Here, the buffer status information includes information on the remaining capacity of each input/output buffer and the remaining capacity can be divided into multiple grades such as empty/almost full/full. The data sorting units 17a through 17n transmit a message for controlling data flow to the physical layer 11 when the remaining capacities of all the input/output buffers 20a through 20n are smaller than a predetermined threshold value.

For example, the data sorting units 17a through 17n generate an interrupt, decrease the number of times of transmitting a signal message or reduce the number of times of transmitting the signal message to one and send the signal message to the processor 40. When a predetermined quantity of data, that is, data that can be burst-transmitted, is stored in an arbitrary input/output buffer among the input/output buffers 20a through 20n, output of data from the input/output buffers 20a through 20n is controlled such that the data is continuously transmitted burst by burst from the arbitrary input/output buffer so as to transmit the signal message only once.

The data sorting units 17a through 17n can select one of the aforementioned methods to control flow of input data and set the size of a transmitted burst. Accordingly, it is possible to minimize harmful effects that can be generated due to frequent interrupt of the processor 40 without disturbing flow of burst input data. The host bridge device 15 and the processor 40 can share status information of the input/output buffers 20a through 20n and status information of the memory 50 of the processor 40 through exchange of the signal message.

The data processing system can include a single input/output buffer or multiple input/output buffers 20a through 20n. The input/output buffers 20a through 20n respectively have lower buffers to classify packets based on their types and the processor 40 has the memory 50 corresponding to the input/output buffers 20a through 20n and the lower buffers.

When there are multiple input/output buffers 20a through 20n, data is output from each of the input/output buffers 20a through 20n by using a buffer output control method such as a round-robin method in each of the input/output buffers 20a through 20n and the buffer output control method can be varied. The input/output buffers 20a through 20n can be omitted when internal buffers of the host interface ports 25a through 25n are used.

Although PCI-Express is used as an interface for connecting the host bridge device 15 to the processor 40 in FIGS. 4, 5, 6, 8 and 9, the interface is not limited thereto and the host bridge device 15 and the processor 40 can use sRIO, parallel PCI, SPI and XAUI and other user-defined and standardized interfaces as described above.

The host interface ports 25a through 25n connect the host bridge device 15 to the processor 40 through PCI-Express interface. Specifically, the host interface ports 25a through 25n perform functions of a physical layer, a link layer, a transfer layer and some of a user layer of a host interface. When output of data from the input/output buffers 20a through 20n to the host interface ports 25a through 25n is selected, buffer output control of the multiple input/output buffers 20a through 20n can be performed by using the round-robin method and the buffer output control method can be varied.

The host bridge device 15 and the processor 40 are connected to each other through a host interface line 31, and thus data can be transmitted between the host bridge device 15 and the processor 40. Input data is loaded in host interface frames 32 and 33 and transmitted. The host interface frames 32 and 33 can be divided into a data frame 32 and a control frame 33. The data frame 32 is loaded with the input data and the control frame is loaded with additional information on the input data. Both the input data and the additional information can be loaded in the data frame 32 and transmitted.

The processor 40 includes an indicator 43 for indicating arrival of input data and at least one memory channel 41a, 41b and 41c storing input data provided to the memory 50. The indicator 43 has different functions for processors and indicates arrival of input data and brief additional information in the current embodiment of the present invention. That is, the indicator 43 activates information related to input data, informs the processor 40 of arrival of the input data and allows the processor 40 to recognize a position of the memory 50 at which the input data is arrived and the type of the input data when the host bridge device 15 transmits the input data to the memory 50. Accordingly, the processor 40 can retrieve the input data from the position of the memory 50 and process the retrieved data. The memory channels 41a, 41b and 41c can use an internal and/or external memory of the processor 40.

The memory 50 includes a plurality of input/output data blocks 51a through 51e and a plurality of meta data blocks 55.

The input/output data blocks 51a through 51e store input data according to data type and can use a ring buffer. Each of the input/output data blocks 51a through 51e has an input point that indicates a position where input data is stored. Input point information is managed and stored by the host bridge device 15. Otherwise, the processor 40 informs the host bridge device 15 of the input point information at any time. When the host bridge device 15 manages the input point, the processor 40 informs the host bridge device 15 of an initial value of the input point and the host bridge device 15 updates the value of the input point whenever input data is stored in the input/output data blocks 51a through 51e.

The meta data blocks 55 store meta data information of input data embedded in the host interface frame. Additional information of input data is stored in each of the meta data blocks 55 or stored for each of the input/output data blocks 51a through 51e or each burst. The meta data blocks 55 store an input line of input data, input sources of the input/output buffers 20a through 20n, additional information corresponding to meta data of the input data, a position where the input data is stored, priority, and information on discrimination between control and user messages based on a signal message transmitted from the host bridge device 15 or signal information transmitted with data to allow the processor 40 to rapidly detect and process information on the input data.

The meta data blocks 55 are respectively provided to the input/output data blocks 51a through 51e and can be included in an internal memory of the processor 40 or the memory 50. The meta data blocks 55 have an input point and an output point. The host bridge device 15 writes information on input data on the input point and the processor 40 reads additional information of data to be processed from the output point and uses the additional information to process the data.

In the configuration of FIG. 4, the host bridge device 15 sends input data to the processor 40 through the following three methods.

A first method transmits the input data to the processor 40 and sends a signal message that informs the processor 40 of the type of the transmitted input data to the processor 40, a second method transmits the signal message to the processor 40 and then sends the input data to the processor 40, and a third method simultaneously transmits the input data and the signal message to the processor 40.

The host bridge device 15 designates the input/output data blocks 51a through 51e of the memory 50, which respectively correspond to the input/output buffers 20a through 20n. When the host bridge device 15 transmits the input data and the signal message to the processor 40, the host bridge device 15 designates an input/output data block among the input/output data blocks 51a through 513 of the memory 50, which will store the input data, reads the input data from the input/output buffers 20a through 20n and transmits the input data to the processor 40.

Then, the input data is stored in the designated input/output data block and meta data of the input data is stored in a corresponding meta data block 55. The processor 40 receives information that represents arrival of the input data from the indicator 43, confirms the additional information of the input data, stored in the meta data block 55, retrieves the input data from the input/output data block and processes the retrieved input data.

Configurations of the input/output buffers 20a through 20n of the host bridge device 15 and the memory 50 of the processor 40 and whether or not to classify input data according to preferred embodiments of the present invention will now be described.

In a first embodiment, the host bridge device 15 uses only a single input/output buffer. In this case, the data sorters 16a through 16n operate only the input/output buffer to extend the size of the input/output buffer. Since only the single input/output buffer is used, the memory 50 of the processor 40 includes a single input/output data block in the form of a ring buffer and does not have the meta data blocks 55.

In the first embodiment, when input data is applied to the data input/output unit 10, the host bridge device 15 retrieves the input data from the input/output buffer and provides the input data to the input/output data block. The input/output data block has an input point to which the input data is input and an output point from which the processor 40 retrieves the input data in order to process the input data.

The processor 40 designates the position of the input/output data block and the input point and informs the host bridge device 15 of the position of the input/output data block in the memory 50 and the input point. The input/output buffer of the host bridge device 15 stores the value of the input point provided by the processor 40 and updates the value of the input point whenever input data is transmitted to the input/output data block of the processor 40. The processor 40 updates the value of the output point whenever data is retrieved from the input/output data block.

When input data is transmitted, meta data of the input data is transmitted simultaneously with the input data, before or after the input data. Both the input data and the meta data are stored in the input/output data block because the memory 50 does not have the meta data blocks 55 in the first embodiment. The processor 40 retrieves the input data together with the meta data from the input/output data block, and thus the processor 40 can simultaneously acquire the input data and additional information required to process the input data.

In a second embodiment, the host bridge device 15 includes the plurality of input/output buffers 20a through 20n and the processor 40 designates as many input/output data blocks 51a through 51e as the number of the input/output buffers 20a through 20n. The processor 40 designates the input/output data blocks 51a through 51e to be used by the input/output buffers 20a through 20n and provides information on the input/output data blocks 51a through 51e to the host bridge device 15. The memory 50 does not have the meta data blocks 55 in the second embodiment.

The data sorters 16a through 16n of the host bridge device 15 sequentially designate the input/output buffers 20a through 20n whenever input data is input and store the input data in the input order without performing an additional sorting operation. The input data is transmitted to the input/output data blocks 51a through 51e respectively corresponding to the input/output buffers 20a through 20n.

When the processor 40 recognizes arrival of input data through the indicator 43, the processor 40 confirms an input/output buffer from which the input data is transmitted using one of a signal message from the indicator 43 or the host bridge device 15 and a status flag register of the host bridge device 15. Then, the processor 40 retrieves the input data from the input/output data block corresponding to the confirmed input/output buffer and processes the retrieved data.

Each of the input/output data blocks 51a through 51e has an input point and an output point. The input point and the output point have the same functions as those of the input/output data block in the first embodiment so that explanation thereof is omitted.

The multiple input/output data blocks 51a through 51e can be constructed in such a manner that the input/output data blocks 51a through 51e are accessed through the different memory channels 41a, 41b and 41c to minimize bottleneck of the memory channels 41a, 41b and 41c, which may occur when input data is stored or retrieved.

In a third embodiment, the host bridge device 15 operates at least one input/output buffer and the processor 40 designates as many as input/output data blocks as the number of input/output buffers, which is similar to the second embodiment, and the data sorters 16a through 16n sort input data, which is different from the first and second embodiments. The processor 40 designates at least one input/output data block corresponding to the at least one input/output buffer and informs the host bridge device 15 of the designated input/output data block.

The data sorters 16a through 16n sort input data using the sorting tables 18a through 18n whenever the input data is input and the sorted input data is stored in a corresponding input/output buffer according to contents. Then, the input data is transmitted to the input/output data block corresponding to the input/output buffer and stored therein.

The processor 40 recognizes arrival of input data through the indicator 43. Then, the processor 40 confirms the input/output buffer from which the input data is transmitted using one of the signal message from the indicator 43 or the host bridge device 15 and the status flag register of the host bridge device 15.

The input/output data block has an input point and an output point. The input point and the output point have the same functions as those of the input/output data block in the first embodiment so that explanation thereof is omitted.

Since the data sorters 16a through 16n of the host bridge device 15 sort input data in the third embodiment, the processor 40 easily recognizes the type of the input data and thus processing resources required to process data can be saved.

Although the memory 50 does not include the meta data blocks 55 in the first, second and third embodiments, it is possible to store a signal message with respect to input data in the meta data blocks 55 and retrieve additional information of the input data from the meta data blocks 55 when the processor 40 requires the additional information if the memory 50 includes the meta data blocks 55. When the meta data blocks 55 are used in the case where the indicator 43 does not provide sufficient additional information to the processor 40, the processor 40 can smoothly process data.

The input/output buffers 20a through 20n of the host bridge device 15 and the memory 50 of the processor 40 can be constructed according to various environments in addition to the first, second and third embodiments and it is possible to minimize a restriction caused by different configurations of internal hardware devices of the data processing system irrespective of the type of the processor 40. The above-described various configurations and supporting methods are prominently effective for absorption, acceptance and transplantation of processing resources required to process data.

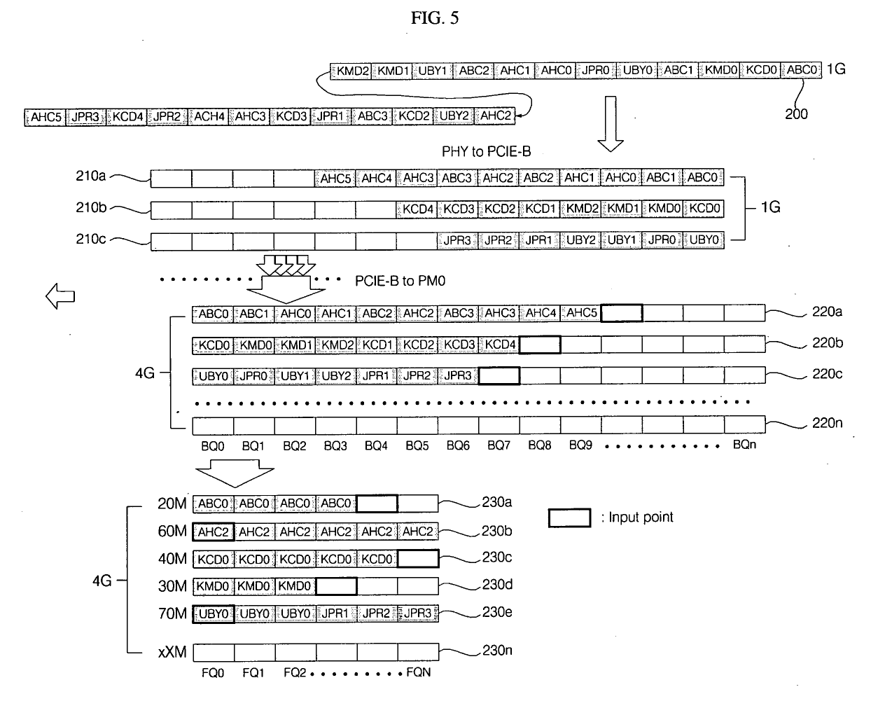

FIG. 5 is a conceptional view illustrating an operation of buffering and processing input data in the data processing system illustrated in FIG. 4. FIG. 5 shows how input data input through the data line connectors 5a through 5n is arranged and processed according to data type.

Input data 200 is input to the data line connectors 5a through 5n within a range allowed by a predetermined line bandwidth. Although the line bandwidth is set to 1G in FIG. 5, the capacity of the line bandwidth can be varied according to the data processing system. The input data 200 is processed such that a data line medium dependent operation is finished in the physical layer 11. Then, the input data is stored in the input/output buffers 20a through 20n of the host bridge device 15.

When the host bridge device has multiple input/output buffers 20a through 20n, the data sorters 16a through 16n sort input data signals 210a, 210b and 210c according to data type, transmit the input data signals 210a, 210b and 210c to the input/output buffers 20a through 20n and stores the input data signals 210a, 210b and 210c therein. Here, a bandwidth is set to each of the input/output buffers 20a through 20n. Although the total bandwidth of the input/output buffers 20a through 20n is set to 1G corresponding to the bandwidth of the data line connectors 5a through 5n in the current embodiment of the present invention, the total bandwidth can be varied by a designer.

When the data processing system includes a plurality of processing modules 30, the input data stored in the input/output buffers 20a through 20n is transmitted to one or plural of the processing modules 30 and stored in the input/output data blocks 51a through 51e and the meta data blocks 55 of the memory 50a through 50n via the memory channels 41a, 41b and 41c of each processing module 30 as represented by reference numerals 220a, 220b and 220c.

The input data processing capability of each processing module 30 is determined according to internal resources and the quantity and bandwidth of input data to be allocated to each processing module are determined according to the internal resources. Input data is distributed to the processing modules 30 through a method of classifying the input data according to data type and selecting processing modules 30 that will process the input data according to the type of the input data, a method of respectively allocating the processing modules 30 to the plurality of data line connectors 5a through 5n, a method of allocating the processing modules 30 for predetermined user input data, a method of allocating the processing modules 30 for respective services, or a method of mixing at least one of the aforementioned methods.

When bandwidths are respectively allocated to the data line connectors 5a through 5n for the respective processing modules 30, flow control through queuing mapping is performed to secure bands of the data line connectors 5a through 5n within the bandwidths. A bandwidth left after the bandwidths are allocated by the processing modules 30 to the data line connectors 5a through 5n can be additionally allocated according to the type of input data.

When the processing modules 30 are selected, input data input through a single data line connector can be transmitted to a single processing module 30, input data input through multiple data line connectors 5a through 5n can be transmitted to a single processing module 30, or input data input through a single data line connector can be allocated to multiple processing modules 30.

The input data is applied to the memory channels 41a, 41b and 41c of the processing module 30 selected through one of the aforementioned methods as represented by reference numerals 230a, 230b and 230c. The input data is subjected to processing, classification, arrangement and transfer in the memory channels 41a, 41b and 41c and stored in the input/output data blocks 51a through 51e and the meta data blocks 55 of the memory 50. Methods of transferring the input data from the memory channels 41a, 41b and 41c to the input/output data blocks 51a through 51e and the meta data blocks 55 include a method of directly transferring the input data from the memory channels 41a, 41b and 41c to the input/output data blocks 51a through 51e and a method of transferring only the additional information of the input data from the memory channels 41a, 41b and 41c to the meta data blocks 55. The memory channels 41a, 41b and 41c and the input/output data blocks 51a through 51e respectively have input points indicating input positions and output points indicating output positions.

The input/output data blocks 51a through 51e can be configured in the form of a plurality of buffers. An output bandwidth can be designated for each buffer and a specific data type can be designated and allocated to a specific buffer.

When universal processors are used as the processing modules 30, a software component such as an OS, a driver or application software constructs a queuing model and a policy with respect to input/output of data. Processing modules capable of queuing input/output data in a hardware manner can be also used as the processing modules 30 of the data processing system according to the current embodiment of the present invention if the processing modules can be interfaced with the data input/output unit 10.

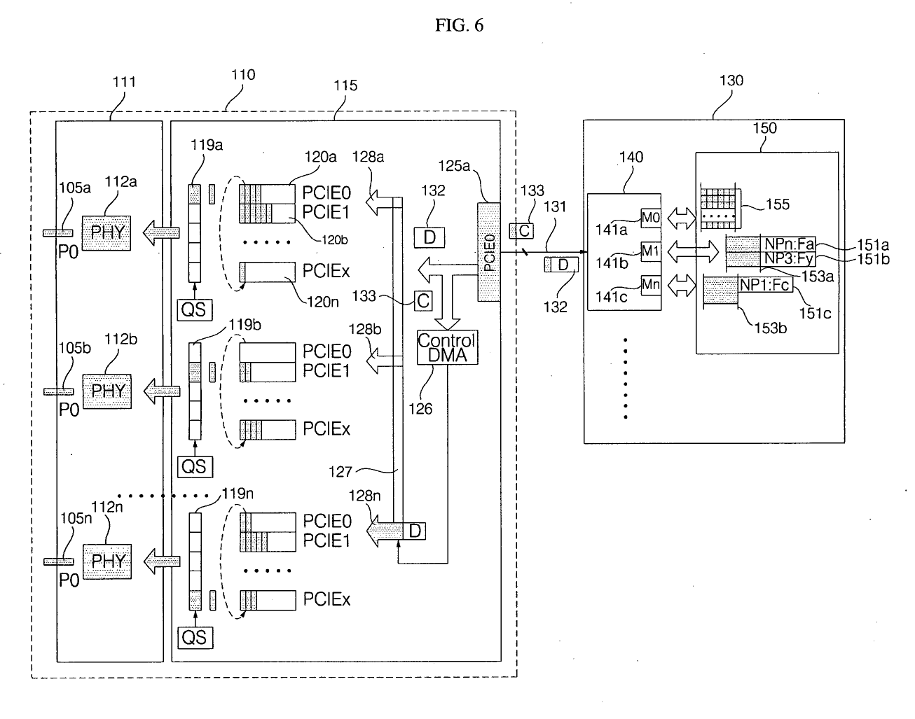

FIG. 6 is a block diagram illustrating configurations of a data input/output unit 110 and a processing module 130 of the data processing system illustrated in FIG. 1 according to an embodiment of the present invention. The data input/output unit 110 and the processing module 130 are constructed based on an output data processing operation.

The processing module 130 includes a processor 140 having a plurality of memory channels 141a, 141b and 141c and a memory 150. The memory 150 includes input/output data blocks 151a through 151e for storing output data and meta data blocks 155 for storing meta data of the output data.

When input data has been processed by the processor 140, the input data is subjected to arrangement or processing to be output and stored in the input/output data blocks 151a through 151e of the memory 150 according to data type. Output data includes meta data. Meta data can be generated for each output data or generated by output data types. The meta data is stored in the meta data blocks 155 included in an internal or external memory of the processor 140. The output data stored in the input/output data blocks 151a through 151e and the meta data stored in the meta data blocks 155 can be accessed via the memory channels 141a, 141b and 141c of the processor 140 and transmitted from the processor 140 to a host bridge device 115 through a host interface line 131. Here, the output data and the meta data are respectively embedded in a data frame 132 and a control frame 133 and transmitted. The meta data can be embedded in the data frame 132 together with the output data and transmitted.

The host bridge device 115 includes a host interface port 125a, a bridge controller 126, an input/output buffer selector 127, input/output buffers 120a through 120n, and line buffer selectors 119a through 119n.

The host interface port 125a extracts output data and/or meta data, which are transmitted from the processor 140 to the host bridge device 115 through the host interface line 131, from the data frame 132 or the control frame 133 and transfers the output data and/or the meta data to a corresponding input/output buffer or the bridge controller 126.

The bridge controller 126 confirms the meta data of the output data and enables output ports 128a through 128n of the input/output buffer selector 127 for transmitting the output data to the input/output buffers 120a through 120n according to the type of the output data. The bridge controller 126 enables the output ports 128a through 128n of the input/output buffer selector 127 before the output data is arrived so as to transfer the output data to a destination input/output buffer. The host interface port 125a can also enable the output ports 128a through 128n of the input/output buffer selector 127.

The input/output buffer selector 127 has the multiple output ports 128a through 128n respectively corresponding to the input/output buffers 120a through 120n. The output ports 128a through 128n are enabled by the bridge controller 126 to transfer output data to the input/output buffers 120a through 120n.

The input/output buffers 120a through 120n stores output data to be transferred to a physical layer 111 and are grouped for each of data line connectors 105a through 105n to which the output data is output.

Input/output buffers 120a through 120n belonging to an arbitrary group temporarily store output data transmitted from the host interface port 125a and transfer the output data to the physical layer 111. Here, the input/output buffers 120a through 120n transmit the output data to the physical layer 111 when the line buffer selectors 119a through 119n open a queue for the input/output buffers 120a through 120n. The line buffer selectors 119a through 119n are selected by using a buffer output control method such as the round-robin method. The buffer output control method can be divided into a control method having intervention of a queue controller and a method having no intervention of the queue controller. For example, when output data is output to an arbitrary output port, the output data can be transmitted to the physical layer 111 through the round-robin method such that the output data is output from the output ports 128a through 128n. If required, weights are given to the input/output buffers 120a through 120n and the number of times of outputting data of the input/output buffers 120a through 120n can be controlled.

The physical layer 111 receives the output data from the input/output buffers 120a through 120n, finishes a data line medium dependent operation in physical layer processors 112a through 112n and outputs the output data to the data line connectors 105a through 105n.

An operation of outputting output data in the data processing system according to the current embodiment of the present invention will now be explained.

When the processor 140 processes input data to generate output data, the output data and meta data are respectively stored in the input/output data blocks 151a through 151e and the meta data blocks 155. Subsequently, the processor 140 informs the host bridge device 115 of positions where the output data and the meta data are stored. Then, the host bridge device 115 respectively retrieves the output data and the meta data from the input/output data blocks 151a through 151e and the meta data blocks 155 via the memory channels 141a, 141b and 141c. The retrieved output data and meta data are provided to the bridge controller 126 through the host interface line 131 and the host interface port 125a. The bridge controller 126 confirms the meta data of the output data and enables the output ports 128a through 128n of the input/output buffer selector 127 through which the output data will pass. The output data is transmitted to the input/output buffers 120a through 120n though the output ports 128a through 128n and stored therein. The output data stored in the input/output buffers 120a through 120n is transferred to the physical layer 111 through the line buffer selectors 119a through 119n. The output data that has been subjected to a data line medium dependent operation in the physical layer 111 is output to the data line connectors 115a through 115n.

FIGS. 4 and 6 illustrate the same data processing system although it seems that the data processing system illustrated in FIG. 4 and the data processing system illustrated in FIG. 6 have different configurations. The operation of the data processing system illustrated in FIG. 4 is described based on input data and the operation of the data processing system illustrated in FIG. 6 is described based on output data, and thus configurations that do not required for the descriptions are omitted. For example, FIG. 4 does not illustrate the bridge controller 126 and the input/output buffer selector 127 that are used only to process output data and FIG. 6 does not illustrate the data sorters 16a through 16n.

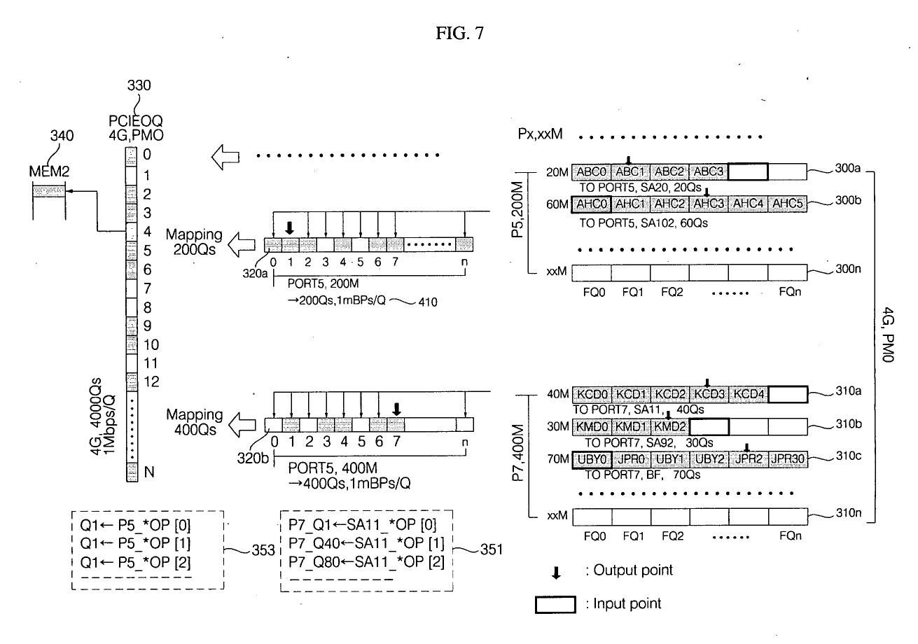

FIG. 7 is a conceptional view illustrating operations of buffering and processing output data in a data processing system according to another embodiment of the present invention.

FIG. 7 is a conceptional view illustrating an operation of sending output data from flow buffers 300a through 300n and 310a through 310n of the processing module 30 to the host interface port 125a of the host bridge device 115 through line output buffers 320a and 320b and a matching buffer 330. Bandwidths are respectively set to the flow buffers 300a through 300n and 310a through 310n, the line output buffers 320a and 320b and the matching buffer 330 in advance. When the processor 40 manages flow of output data, the processing module 30 not only considers the bandwidths of the flow buffers 300a through 300n and 310a through 310n and the line output buffers 320a and 320b but also manages and controls a bandwidth per line, which defines the bandwidth of output data transmitted from the flow buffers 300a through 300n and 310a through 310n to the line output buffers 320a and 320b.

In the embodiment illustrated in FIG. 7, a plurality of flow buffers are allocated to a single line output buffer and the bandwidth of the single line output buffer and the bandwidths of the plurality of flow buffers allocated to the single line output buffer must be considered. Accordingly, when the processing module 30 transmits output data from the flow buffers 300a through 300n and 310a through 310n to the line output buffers 320a and 320b, the bandwidths of the line output buffers 320a and 320b and the flow buffers 300a through 300n and 310a through 310n are allocated such that queues of the line output buffers 320a and 320b, which correspond to the bandwidth of each flow buffer, are used when output data and/or meta data stored in the flow buffers 300a through 300n and 310a through 310n are input to queues of the line output buffers 320a and 320b and the output data and/or the meta data are arranged at an equal interval in the line output buffers 320a and 320b in order to control transmission of the output data according to the bandwidth of each of the flow buffers 300a through 300n and 310a through 310n in the allocated bandwidth per line.

The line output buffers 320a and 320b have information on the bandwidth of each of the flow buffers 300a through 300n and 310a through 310n of the processing module 30 for each data line connector, the number of queues of the flow buffers and a bandwidth per queue. The line output buffers 320a and 320b allocate queues corresponding to a predetermined bandwidth according to the type of output data based on the information and control the interval of the allocated queues in such a manner that the queues are arranged at an equal interval to adjust the predetermined bandwidth according to the type of output data output to a corresponding data line connector. Each of the line output buffers 320a and 320b has an input point for indicating a position to which output data is input and an output point for indicating the position of output data output to the matching buffer 330. The line output buffers 320a and 320b separately manage their input points for each of the flow buffers 300a through 300n and 310a through 310n and share information on the input points with the flow buffers 300a through 300n and 310a through 310n.

The flow buffers 300a through 300n and 310a through 310n store the input points together with a queue list corresponding to a group of queue numbers and/or queue addresses of the line output buffers 320a and 320b, which are formed according to queue allocation and queue interval control in the matching buffer 330, and apply output data stored in the flow buffers 300a through 300n and 310a through 310n to the input points of the line output buffers 320a and 320b based on information included in the queue list. Each of the flow buffers 300a through 300n and 310a through 310n has an input port for indicating a position to which data is input and an output point for indicating a position from which data is output. For example, SA11 (Service Agreement 11) output data is output through a port 7, a bandwidth allocated to the data type is 40 Mbps and a bandwidth per queue of the line output buffers 320a and 320b is 1 Mbps. Accordingly, 40 queues of the line output buffers 320a and 320b must be allocated for the SA11 output data and the interval of the output data must correspond to 40 queues. That is, the input points of the line output buffers 320a and 320b indicate a queue 1, a queue 40 and a queue 80 and output data and/or meta data designated by the output points of the flow buffers 300a through 300n and 310a through 310n are input to the queues 1, 40 and 80 indicated by the input points of the line output buffers 320a and 320b.

When output data signals of various kinds are allocated to the queues of the line output buffers 320a and 320b at a predetermined interval, some queues may be overlapped. In this case, the output data is input to empty queues among queues following the overlapped queues. According to this method, drop of output data caused by output congestion of the line output buffers 320a and 320b can be limited in the corresponding data flow.

The matching buffer 330 temporarily stores output data output from the line output buffers 320a and 320b before the output data is transmitted to the host bridge device 115, manages and controls flow of the output data according to the bandwidth per line, which is allocated to the processing module 30. The matching buffer 330 includes a plurality of queues and a bandwidth per queue of the matching buffer 330 is determined by the number of queues of the matching buffer 330 and the bandwidth of the processing module 30. The matching buffer 330 allocates the queue list to the line output buffers 320a and 320b within the bandwidth per line and the line output buffers 320a and 320b store the allocated queue list and provides the queue list to the flow buffers 300a through 300n and 310a through 310n.

Contents stored in the queues of the matching buffer 330 can be output data or meta data such as an address designating data. In the case where the contents stored in the queues of the matching buffer 330 correspond to the meta data, output data corresponding to the meta data is retrieved from a memory that stores the output data based on address information designated for the output data, which is included in the meta data, and output to the host interface line when the output data is transmitted. The matching buffer 330 also has an input port and an out port identical to those of the line output buffers 320a and 320b, separately manages the input point for each of the line out buffers 320a and 320b and shares information on the input point with the line output buffers 320a and 320b.

The flow buffers 300a through 300n and 310a through 310n, the line output buffers 320a and 320b and the matching buffer 330 can be located in an internal or external memory of the processor or placed in both the internal and external memories.

Numerical values such as capacities of buffers and data are exemplary and the present invention is not limited thereto.

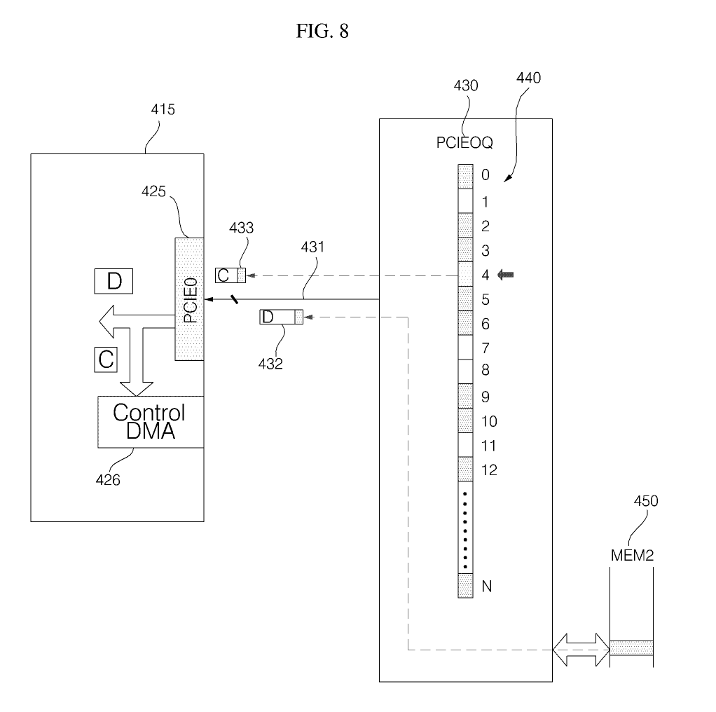

FIG. 8 is a block diagram illustrating transmission of output data between a host bridge device 415 and a processing module 430 in the data processing system illustrated in FIG. 7.

The host bridge device 415 reads meta data of output data from a queue designated by an output point of a matching buffer 440 of the processing module 430 and retrieves the output data from a memory 450. Here, the host bridge device 415 can retrieve the output data through various methods.

In a first method mainly performed by a bridge controller 426, the bridge controller 426 has information on the output point of the matching buffer 440 and reads meta data of the output data from a corresponding queue of the matching buffer 440 when the meta data of the output data is stored in the matching buffer 440. Then, the bridge controller 426 reads the output data from the memory 450 based on an address value of the output data, which is designated by the meta data, and retrieves the output data through a host interface line 431. In a second method performed by the processing module 430, the processing module 430 provides the meta data of the output data, which is designated by the output point of the matching buffer 440, to the bridge controller 426 when the meta data of the output data is stored in the matching buffer 440. The bridge controller 426 detects the position of the output data in the memory 450 from the meta data of the output data and retrieves the output data from the position of the memory 450. In a third method mainly performed by the bridge controller 426, the bridge controller 426 has information on the output point of the matching buffer 440 and directly reads the output data from the corresponding queue of the matching buffer 440 when the output data is stored in the matching buffer 440. The output data can be transmitted from the processing module 430 to the host bridge device 415 through various methods other than the aforementioned methods if required.

Output data 432 and a signal message 433 transmitted to the host bridge device 415 are classified in a host interface port 425, some of control/status messages are transmitted to the bridge controller 426 and the output data is sent to one of output ports of an input/output buffer selector (not shown).

When capacity of a buffer of an arbitrary output port exceeds a threshold value while the output data is transmitted, an operation of processing the output data provided to the output port from the queue of the matching buffer 440 of the processing module 430 is omitted and the output point of the matching buffer 440 is moved to the next queue to process output data allocated to another output port. To achieve this, a processor of the processing module 430 reads status information of input/output buffers from the host bridge device 415. Exchange of the status information can be performed through the host interface line 431 corresponding to a data path, an additional channel or both the host interface line 431 and the additional channel.

FIG. 9 is a block diagram of a data processing system according to another embodiment of the present invention. The data processing system illustrated in FIG. 9 includes an upper processing module 550 that manages a plurality of processing modules 530a through 530n. FIG. 9 illustrates a method of flexibly varying output of output data while maintaining an output bandwidth allocated to each of the processing modules 530a through 530n when the output data is output to a single data line connector 505.

The data processing system includes the plurality of processing modules 530a through 530n, the upper processing module 550 having status information on the processing modules 530a through 530n, and a host bridge device 515.

The upper processing module 550 includes an output table with respect to the data line connector 505. The output table 555 stores an output bandwidth 551, capacity used 552, at least one threshold value 553 and a lending margin 554 with respect to the data line connector 505 for each of the processing modules 530a through 530n.

The processing modules 530a through 530n can be packet processing modules and respectively include line matching buffers 541a through 541n that store output data transmitted to the data line connector 505. The processing modules 530a through 530n have information on the line matching buffers 541a through 541n, for example, information on output bandwidths, current capacities and a threshold value of the line matching buffers 541a through 541n, share this information with the upper processing module 550 and store the information in the output table 555.

The line matching buffers 541a through 541n of the processing modules 530a through 530n respectively have output points, retrieve output data from queues corresponding to the output points and transmit the output data to host interface ports 525a through 525n of the host bridge device 515.

The upper processing module 550 and the processing modules 530a through 530n are connected to a control message switch 565 through a control interface line 560 to exchange and share information. In addition to this method, the upper processing module 550 and the processing modules 530a through 530n exchange and share information by using input/output data paths based on the host bridge device 515. Otherwise, the two methods can be simultaneously used. The input/output data paths based on the host bridge device 515 include host interface lines through which data is input/output between the host bridge device 515 and the processing modules 530a through 530n.

The processing modules 530a through 530n transmit/receive a control message and a data message to/from the host bridge device 515 through the host interface lines. The control message loads and transfers status information on various buffers including the line matching buffers 541a through 541n of the processing modules 530a through 530n and input/output buffers of the host bridge device 515 and meta data of input data and output data and the data message loads and transfer the input data and the output data.

Bridge controllers 526a through 526n of the host bridge device 515 process the control message transmitted from the processing modules 530a through 530n, check the states of the input/output buffers and manage the states or provide information on the states of the input/output buffers to the processing modules 530a through 530n.

Output data of the input/output buffers is transmitted to the data line connector 505 according to a buffer output control method such as the round-robin method.

In the data processing system having the aforementioned configuration, the bandwidth of a specific processing module among the processing modules 530a through 530n with respect to the data line connector 505 exceeds a predetermined threshold value, the upper processing module 550 confirms the output table 555 and lends the bandwidth of a processing module having remarkably small capacity used to the specific processing module. For example, a bandwidth obtained by subtracting capacity used and a lending margin from the threshold value of a processing module having the smallest capacity used (bandwidth that can be lent=threshold value−capacity used−lending margin) can be lent to the specific processing module. Lending of a bandwidth can be performed because the upper processing module 550 includes the output table 555 and shares status information of the line matching buffers 541a through 541n of the processing modules 530a through 530n.

When other processing modules other than the specific processing module cannot lend their bandwidths to the specific processing module although the bandwidth of the specific processing module exceeds the predetermined threshold value, the processing modules 530a through 530n transfer SA (Service Agreement) data and drop BF (Best Effort) data. Generally, the SA data is allocated in consideration of bandwidths of output ports of the processing modules 530a through 530n, and thus the SA data can be output without being dropped.

Accordingly, when BF data is over-crowed to a specific processing module, the bandwidth of a processing module other than the specific processing module can be lent to the specific processing module.

In the data processing system having the aforementioned configuration, the processing modules are constructed in such a manner that the processing modules can support a plug-and-play function. Furthermore, the processing modules can be constructed in such a manner that the processing modules or the upper processing module and other processing modules share information on the functions thereof or memory states to easily change or modify the processing modules and easily detect change or modification of the processing modules. Accordingly, distribution of data to be processed according to change or modification of the processing module can be adaptively performed. Moreover, the host bridge device and the processing modules classify input data and output data according to data type (flow) and store the input data and the output data in the input/output buffers of the host bridge device or the memory of the processing modules, and thus it is easily allocate the processing modules or processors for processing data.

In the case where a part is ‘connected’ to another part, the case not only includes a case where the part is ‘directly connected’ to the other part but also a case where the part is ‘indirectly connected’ to the other part having another element between them in the entire specification. Furthermore, to ‘include’ a component does not mean to exclude other components and means to able to include the other components as long as there is no opposite mention.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A data processing system comprising:
at least one processing module having at least one processor processing data; and
a data input/output unit classifying and buffering input data received from an external medium, applying the input data to a processing module capable of processing the input data among the at least one processing module such that the input data is processed, classifying and buffering output data processed by the at least one processing module and outputting the output data to an external device.

2. The data processing system of claim 1, wherein the data input/output unit comprises a host bridge device comprising a plurality of input/output buffers storing the input data, a data sorter for sorting the input data according to data type, and an input/output buffer selector for selecting a input/output buffer corresponding to the type of the input data sorted by the data sorter and storing the input data in the selected input/output buffer.

3. The data processing system of claim 2, wherein the host bridge device further comprises:
an input/output buffer selector having a plurality of output ports and providing output data processed by and transmitted from the processing module to the input/output buffers; and
a bridge controller confirming meta data of the output data to determine an input/output buffer in which the output data will be stored, enabling an output port corresponding to the input/output buffer and controlling the output data to be stored in the input/output buffer.

4. The data processing system of claim 1, wherein each of the at least one processing module comprises:
a plurality of input/output data blocks storing the input data and the output data according to data type; and
a memory having meta data blocks storing meta data of the input data and meta data of the output data.

5. The data processing system of claim 1, wherein each of the processing module comprises:
a plurality of flow buffers storing output data processed by the processor according to data type;
at least one line output buffer allocating a predetermined bandwidth, queues, a bandwidth per queue, and the number of queues according to the type of the output data to the processing module in order to process data of an arbitrary external medium and controlling the interval of the queues to arrange the queues at an equal interval; and
a matching buffer controlling the number of queues allocated to each of the at least one line output buffer according to the number of queues and the bandwidth of the processing module.

6. The data processing system of claim 1, wherein one of the at least one processing module is an upper processing module that allocates the bandwidth of a processing module among the at least one processing module to a specific processing module among the at least one processing module when the bandwidth of output data of the specific processing module exceeds a predetermined threshold value such that the specific processing module can use the allocated bandwidth.

7. The data processing system of claim 6, wherein the upper processing module shares information on the bandwidth, capacity used, a threshold value and a lending margin of each of the at least one processing module with the at least one processing module and a bandwidth that can be lent is calculated in such a manner that the capacity used and the threshold value are subtracted from the bandwidth.

8. The data processing system of claim 1, wherein the at least one processing module performs at least one of system control, packet processing and connection control functions, shares information on the functions and distributes data to be processed according to the functions.

9. The data processing system of claim 1, further comprising a plurality of connectors connected to an interface that is connected to the at least one processing module to connect the processing module to the data input/output unit.

10. The data processing system of claim 1, further comprising a switch connector connecting the at least one processing module to a plurality of other processing modules to increase the quantity of data processed, wherein the plurality of other processing modules are connected to an additional data input/output unit.
